(19) United States
(12) Patent Application Publication
(10) Pub. No.: US 2016/0339282 A1
(43) Pub. Date: Nov. 24, 2016

(54) Methods and Apparatus for a Fire Suppression System

(71) Applicant: Firetrace USA, LLC, Scottsdale, AZ (US)

(72) Inventor: David Laurence Melton, Ipswich (GB)

(21) Appl. No.: 15/228,247

(22) Filed: Aug. 4, 2016

Related U.S. Application Data
(63) Continuation-in-part of application No. PCT/US2015/054392, filed on Oct. 7, 2015.

(30) Foreign Application Priority Data
Oct. 17, 2014 (GB) 1418505.2

(51) Int. Cl. A62C 35/13; A62C 35/02

(52) U.S. Cl. CPC A62C 35/13; A62C 35/023

(57) ABSTRACT

The present technology provides a bi-directional control valve for a fire suppression system. In particular, this bi-directional control valve comprises an inlet, a first fluid communication passageway or outlet (port) and a second fluid communication passageway or outlet (port). The first outlet port is configured to be connected to a detector tube as part of a direct system and the second outlet port is configured to be connected to a discharge tube as part of an indirect system. The detector tube comprises a heat sensitive tube suitably configured to rupture or otherwise lose integrity as a result of exposure to heat associated with exposure to a fire condition. As a result of this rupture, a pressure contained within the detector tube will be released and then acts as a signal to actuate the bi-directional control valve such that the fire extinguishant contained within a cylinder is simultaneously released through the detector tube and the discharge tube.

### CROSS-REFERENCES TO RELATED APPLICATIONS

This application is a continuation-in-part of International Application No. PCT/US15/54392, filed Oct. 7, 2015, which claims benefit to United Kingdom Patent Application No. GB 1418505.2, filed Oct. 17, 2014 and incorporates the disclosure of each application by reference. To the extent that the present disclosure conflicts with any referenced application, however, the present disclosure is to be given priority.

### BACKGROUND OF THE TECHNOLOGY

A fire extinguishing system generally includes a pressurized cylinder containing an extinguishant. Such fire suppression systems may be installed in fire hazard areas such that the extinguishant is released automatically when a fire is detected. In some fire suppression systems the pressurized cylinder can be connected to a length of detection tubing that may also be pressurized. The length of the detection tubing comprises an outer wall which is configured to rupture when exposed to heat associated with a nearby fire and allow the extinguishant to be released through the rupture. Accordingly, with such systems, the extinguishant will be automatically and directly released in the proximity of the fire.

The detection tubing is positioned and secured in a fire risk area for which the system is designed to protect. If a fire subsequently starts within this area then the heat will rupture the detection tubing at or near the hottest area. This rupture causes a loss in pressure of the detection tubing which in turn releases the extinguishant from the pressurized cylinder. The extinguishant then flows through the detection tubing to the location of the rupture where the extinguishant then extinguishes, or at least suppresses, the original source of the fire.

Similar systems are available which are called indirect automatic fire suppression systems. In these systems, the extinguishant is configured to be discharged through a diffuser head or nozzle coupled to a discharge tube. Accordingly, the extinguishant does not flow through the detection tubing and out of the rupture. These indirect systems generally include a valve which is controlled by the pressure in the detection tubing such that the valve is opened when pressure is released from the detection tubing. On the release of this pressure, the discharge valve opens and the extinguishant flows through the discharge tube and out of the diffuser head.

A user or installer therefore has the option of selecting whether to use a direct fire suppression system or an indirect fire suppression system depending upon the particular circumstances. For example, to protect an area having multiple chambers, an indirect system may be selected in which a diffuser head is located in each of the chambers. Alternatively, a direct system may be installed where it is preferred to only have the source of the heat directly extinguished without having to guess where to install a diffuser head. A direct system may therefore be more targeted and prevent any components or equipment being unnecessarily covered with an extinguishant.

### SUMMARY OF THE TECHNOLOGY

The present technology provides a bi-directional control valve for a fire suppression system. In particular, this bi-directional control valve comprises an inlet, a first fluid communication passageway or outlet (port) and a second fluid communication passageway or outlet (port). The first outlet port is configured to be connected to a detector tube as part of a direct system and the second outlet port is configured to be connected to a discharge tube as part of an indirect system. The detector tube comprises a heat sensitive tube suitably configured to rupture or otherwise lose integrity as a result of exposure to heat associated with exposure to a fire condition. As a result of this rupture, a pressure contained within the detector tube will be released and then acts as a signal to actuate the bi-directional control valve such that the fire extinguishant contained within a cylinder is simultaneously released through the detector tube and the discharge tube.

### BRIEF DESCRIPTION OF THE DRAWINGS

A more complete understanding of the present technology may be derived by referring to the detailed description and claims when considered in connection with the following illustrative figures. In the following figures, like reference numbers refer to similar elements and steps throughout the figures.

FIG. 1 is a side cross-section schematic view of a preferred embodiment of a bi-directional control valve in accordance with the present technology with the valve in the closed position;

FIG. 2 is a side cross-section schematic view of a preferred embodiment of the bi-directional control valve in accordance with the present technology with the valve in the open and activated (discharging) position;

FIG. 3 is a side cross-section schematic view of another embodiment of the bi-directional control valve in accordance with the present technology with the valve in the closed position;

FIG. 4 is a side cross-section schematic view of a further embodiment of the bi-directional control valve in accordance with the present technology with the valve in the closed position;

FIG. 5 is a top view of a valve member for use in the bi-directional control valve in accordance with the present technology;

FIG. 6 is a side view of the valve member for use in the bi-directional control valve in accordance with the present technology;

FIG. 7 is a bottom view of the valve member for use in the bi-directional control valve in accordance with the present technology;

FIG. 8 is a schematic view of a preferred embodiment of a fire suppression system in accordance with the present technology;

FIG. 9 is a schematic view of another embodiment of a fire suppression system in accordance with the present technology;

FIG. 10 is a side cross-section schematic view of an alternative embodiment of a bi-directional control valve in accordance with the present technology with the valve in the closed position; and

FIG. 11 is a side cross-section schematic view of an alternative embodiment of the bi-directional control valve in accordance with the present technology with the valve in the closed position.

Elements and steps in the figures are illustrated for simplicity and clarity and have not necessarily been rendered according to any particular sequence. For example, steps that may be performed concurrently or in a different order are illustrated in the figures to help to improve understanding of embodiments of the present technology.

### DETAILED DESCRIPTION OF EXEMPLARY EMBODIMENTS

The present technology may be described in terms of functional block components and various processing steps. Such functional blocks may be realized by any number of hardware or software components configured to perform the specified functions and achieve the various results. For example, the present technology may employ various containers, sensors, detectors, control materials, valves, and the like, which may carry out a variety of functions. In addition, the present technology may be practiced in conjunction with any number of hazards, and the system described is merely one exemplary application for the technology. Further, the present technology may employ any number of conventional techniques for delivering hazard control materials, sensing hazardous conditions, controlling valves, and the like.

Methods and apparatus for a fire suppression system according to various aspects of the present technology may operate in conjunction with any system, device, or area requiring protection against fire. Various representative implementations of the present technology may be applied to any system for suppressing fires or controlling other hazardous conditions, such as chemical spills. Certain representative implementations may include, for example: portable and/or non-portable containers, equipment enclosures, cargo containers, engine bays, electrical housings and cabinets, fixed storage units, or any other open or closed area requiring fire protection.

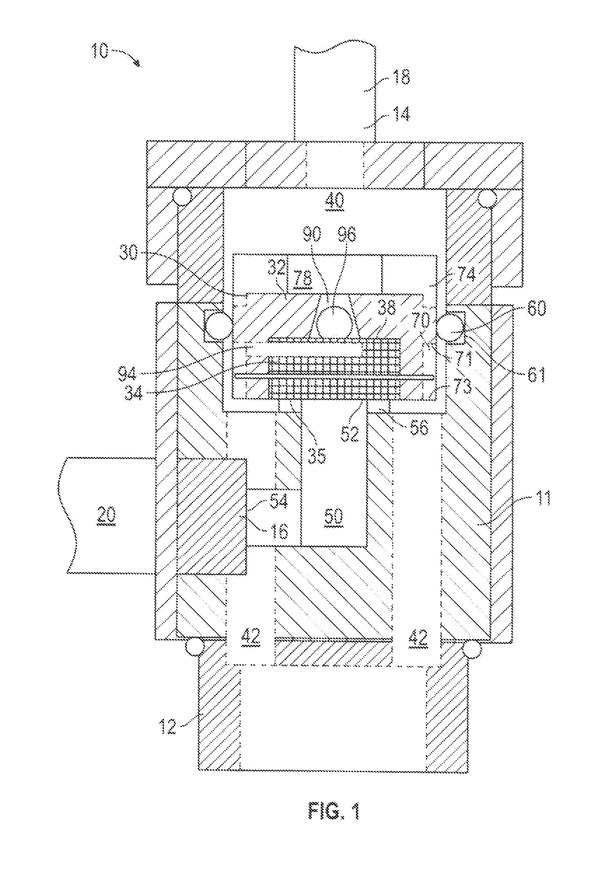

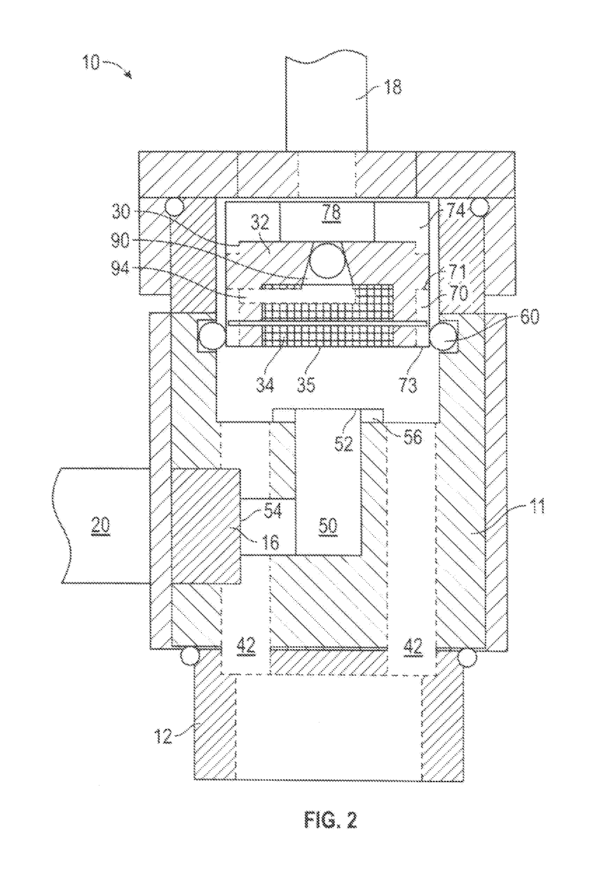

Prior art fire suppression systems often provide a direct discharge system using a single outlet port or an indirect discharge system using a single outlet port. Accordingly, the present technology now provides a fire suppression system which enables a combination of both a direct extinguishant release and an indirect extinguishant release. For example, and referring now to FIGS. 1 and 2, an exemplary embodiment of a multi-directional control valve may comprise a bi-directional control valve 10. The control valve 10 may be configured for use with a fire suppression system and may comprise a valve body 11 having an inlet 12, a first fluid communication passageway or outlet port 14, and a second fluid communication passageway or outlet port 16. In one embodiment, the first outlet port 14 is configured to be connected to a detector tube 18 associated with a direct release system and the second outlet port 16 is configured to be connected to a discharge tube 20 associated with an indirect system.

The control valve 10 may further comprise a detector chamber 40 positioned within the valve body 11 and a valve member 30 configured to move within the detector chamber 30. The valve member 30 may comprise a first part and a second part. The first part generally comprises a carrier component 32 and the second part generally comprises a sealing component 34. The sealing component 34 is mounted on the carrier component 32 and the sealing component 34 is carried by the carrier component 32. The valve member 30 may further comprise an internal valve mechanism which acts to maintain an optimum operational pressure with the detector tube 18 as will be described later. The combination of this valve member 30 together with a valve housing formed from the valve body 11 of the control valve 10 enables two fluid flow paths (first and second fluid communication passageways) to be created (simultaneously) by the release of pressure from the detector tube 18.

The detector tube 18 may be configured to be held under a predetermined internal pressure until exposed to a flame, elevated ambient temperatures generally associated with a fire, or a particular energy level associated with a fire. For example, in one embodiment, the detector tube 18 may comprise a heat sensitive tube configured to be structurally compromised as a result of exposure to significant heat. Exposure of the detector tube 18 to the elevated heat may cause the structural integrity of the detector tube 18 to degrade until the detection tube ruptures, leaks, bursts, or otherwise loses internal pressure. For example, an opening in the detector tube 18 may result from the degradation in structural integrity at a location where the flames of the fire come into contact with the detector tube 18.

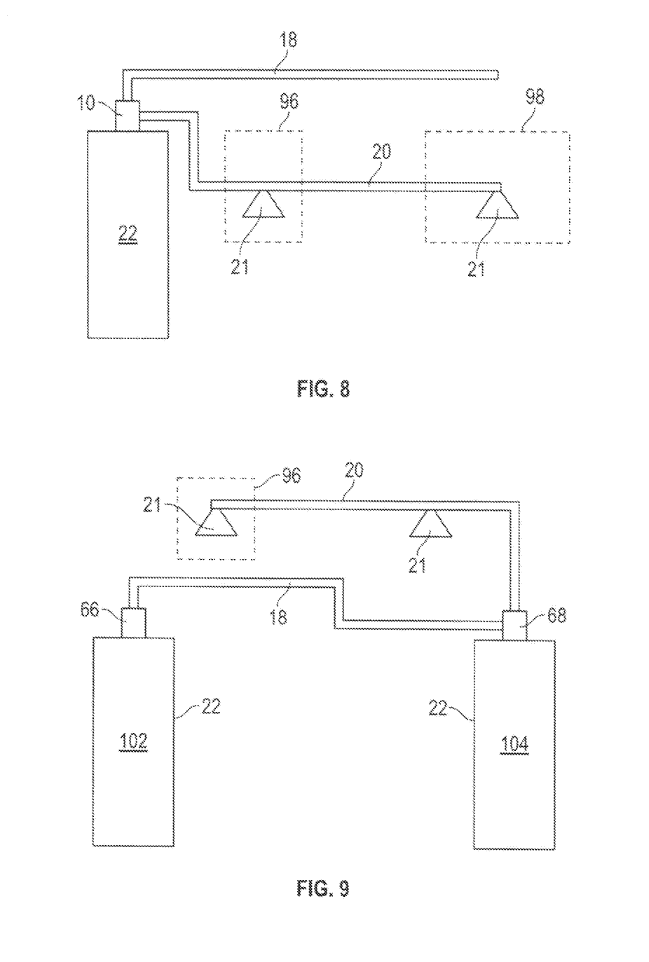

As a result of this rupture, the pressure contained within the detector tube 18 will be released causing the control valve 10 to actuate such that the fire extinguishant contained within a cylinder 22 (shown in FIG. 8) is simultaneously released through the detector tube 18 and also through the discharge tube 20. It should be noted that the discharge tube 20 is separate from the detection tube 18 even though the detection tube 18 actually functions to discharge extinguishant through the heat/fire created rupture. In addition, the detection tube 18 is pressurized whereas the discharge tube 20 may be unpressurized.

With continued reference to FIG. 1, in a normal and un-activated state, the control valve 10 does not provide any fluid communication passageways through the control valve 10. In this state, pressurized extinguishant is contained within the cylinder 22 or other containment vessel. The detector tube 18 may be attached to the first outlet port 14. The outlet port 14 may not solely function as an outlet but may be suitably configured to allow fluid flow in both directions. The detector tube 18 may be pressurized such that the pressure in the detector tube 18 and an associated detector chamber 40 acts on a first side of the valve member 30 to urge it into a closed position.

The valve body 11 may also comprise a primed chamber 42 disposed between the inlet and the detector chamber 40. The primed chamber 42 may be suitably configured to be in fluid communication with the pressurized extinguishant contained within the cylinder 22. The primed chamber 42 may generally be disposed on the opposite side of the valve member 30 with respect to the detector chamber 40 so that the pressure within the primed chamber 42 acts on a second side of the valve member 30. Pressure differentials between the first and second sides of the valve member 30 cause the valve member 30 to move within the detector chamber 40.

The valve member 30 is contained within the valve body 11 of the control valve 10 by a seal 60 comprising an O-ring seal. This seal 60 together with the valve member 30 effectively partitions the detector chamber 40 from the primed chamber 42 to prevent fluid flow between the two chambers. In one embodiment, the O-ring may be statically positioned in a groove 61 located along an internal wall of the valve body 11. The valve member 30 may be configured to sealingly move within the detector chamber 40 and against the O-ring.

For example, in an initial primed condition, the force created by pressure within the detector chamber 40 is greater than the force created by the pressure within the primed chamber 42. These unbalanced forces result in the valve member 30 being biased towards the primed chamber 42 and the closed position.

The pressure within the primed chamber 42 may act on a lesser surface area of the valve member 30 compared to the pressure within the detector chamber 40. The valve body 11 may further include a central portion 50 to provide a passageway to the second outlet 16. For example, the central portion 50 may comprise a cylindrical body which is centrally and concentrically arranged with the respect to a generally cylindrical valve body 11.

The central portion 50 provides a passageway which extends from an entry region 52 to an exit region 54 proximate the second outlet port 16. The entry region 52 is surrounded by an annular seal providing an annular sealing face 56. With the control valve 10 in the closed and active position, the annular sealing face 56 is positioned to abut and seal against the valve member 30 to prevent any flow of extinguishant from the cylinder 22 through the primed chamber 42 and into the discharge tube 20. In particular, the annular sealing face 56 is arranged to seal against a sealing face 35 of the sealing component 34 of the valve member 30.

The central portion 50 thereby prevents the valve member 30 from being exposed to a full maximum potential force created by the pressure within the primed chamber 42 to a certain extent. The pressure contained within the primed chamber 42 acts against only an annular area of the valve member 30 defined around this central portion 50 and/or the annular sealing face 56. Accordingly, as mentioned above, the pressure within the primed chamber 42 acts on a smaller surface area compared to the pressure within the detection chamber 40.

During installation and activation of the fire suppression system, the detector tube 18 is pressurized. As indicated above, the pressure in the detector tube 18 and hence in the detection chamber 40 produce a force on the valve member 30 which is great enough to maintain the valve member 30 in a closed position with the sealing face 35 of the sealing component 34 sealing the cylinder 22 contents from the second outlet port 16.

The detector tube 18 may be pressurized to a level substantially equivalent to a pressure of the cylinder 22 that holds the extinguishant. Alternatively, the detector tube 18 may be pressurized to a level higher than that of the cylinder 22, creating a pressure differential at the valve member 30 that may range between 10-600 pounds per square inch (psi).

Referring now to FIG. 2, if exposed to heat or fire, the detector tube 18 may rupture causing the pressure contained within the detector tube 18 to be released to the atmosphere. This will cause a rapid decrease or loss in the pressure contained within the detector tube 18 and the detection chamber 40 until the force applied on the valve member 30 from within the primed chamber 42 overcomes the force applied from the detection chamber 40. This reversal of the order of the balance of the forces will cause the valve member 30 to move within the valve body 11 away from the entry region 52. In particular, the valve member 30 will move away from the primed chamber 42 and into or towards the detection chamber 40.

With continued reference to FIG. 2, the movement of the valve member 30 causes the sealing face 35 of the sealing component 34 of the valve member 30 to be spaced from the annular sealing face 56 surrounding the entry region 52 to the passageway of the second outlet port 16. Accordingly, this opens the second outlet port 16 and enables the pressurized extinguishant to be released from the cylinder 22 through the second outlet port 16 and into the discharge tube 20. The extinguishant may flow through the discharge tube 20 towards one or more discharge heads to enable the extinguishant to be released at pre-determined locations.

As the valve member 30 moves from the closed position to an open position, the valve member 30 is configured to simultaneously open a passageway between the pressurized extinguishant in the cylinder 22 and the detector chamber 40. This provides for a simultaneous release of extinguishant to the source of the detected heat/fire through the detector tube 18 as well as a release of extinguishant to the pre-determined locations through the discharge tube 20.

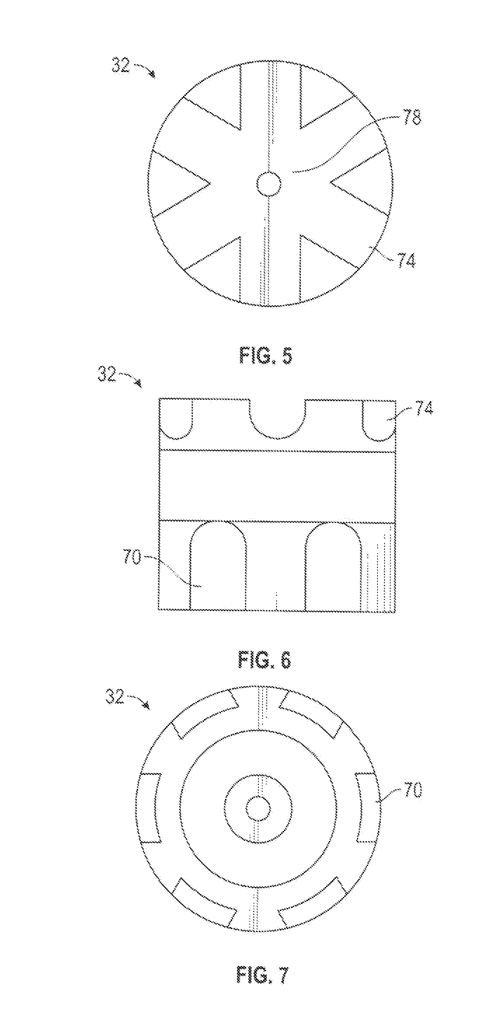

Referring now to FIGS. 1, 2, 5, 6, and 7, the second part or carrier component 32 of the valve member 30 comprises a first series or array of grooves 70, splines or ribs. The first array of grooves 70 are provided around the outer surface of the carrier component 32. The first array of grooves 70 extend longitudinally down along an outer surface for at least a portion of the length of the carrier component 32. In particular, a length of the first array of grooves 70 is such that in the closed position, a top edge portion 71 of the first array of grooves 70 is positioned below the seal 60. A lower edge portion 73 of the first array of grooves 70 may be open to the primed chamber 42.

As the valve member 30 moves towards the open position, the top edge portion 71 of the first array of grooves 70 will move towards the seal 60. At a critical position, the top edge portion 71 of the first array of grooves 70 will pass over the seal 60 enabling fluid to flow from the primed chamber 42 through the first array of grooves 70 and flow past the seal 60 and into the detection chamber 40.

The carrier member 32 may also comprise a second series or array of grooves 74, splines or ribs. The second array of grooves 74 provides a passageway from a distal side of the seal 60 into a central void 78 and out of the first outlet port 14. Accordingly, this provides a simultaneous activation of a first fire suppression supply through the actual detector tube 18 and out of the rupture, together with a second fire suppression supply though the discharge tube 20 and through the discharge head(s).

If there is a leak or fault within the discharge tube 18 or a change of pressure caused by temperature etc. then this may create a risk of a release of extinguishant or pressure from the system and the fire suppression system would fail. For example, a slow release of pressure would cause the valve member 30 to slowly open in order for the extinguishant to be released through the discharge tube 20 and any discharge heads and/or from the site of the leak. The discharge tube 20 and any discharge heads may actually be unpressurised and/or open to allow any free flow of air into and out of the discharge tube 20. Overall, any release or leak or change of pressure in the detection tube 18 could have significant consequences. For example, a slow release of pressure from the detector tube 18 may eventually cause the system to be falsely activated.

The present technology may further provide an equalizing function to automatically re-pressurize the detection tube 18 if the detection tube 18 slowly loses pressure. For example, the valve member 30 may comprise a re-pressurizing or equalizing passageway 90 including an internal valve mechanism. In particular, the carrier component 32 may be configured to define the equalizing passageway 90 defined therethrough. The equalizing passageway 90 cooperates with a corresponding passageway 94 of the sealing member 34. These two passageways connect to provide a continuous passageway from the primed chamber 42 to the detection chamber 40. However, an internal valve mechanism is arranged to selectively restrict the flow through this connecting passageway.

The internal valve mechanism may comprise a ball 96 or spherical valve member which is configured to seal the equalizing passageway 90 on the detection of a fire. In a normal inoperative condition, the ball 94 is contained within the equalizing passageway 90 but there is an equalizing passageway extending from the detection chamber 40 to the primed chamber 42 such that the pressures will be equalized. Referring again to FIG. 1, a greater pressure within the detection chamber 40 would only force the ball member 94 away from the tapered or flared sealing surface of the equalizing passageway 90. A slight decrease or gradual decrease in the pressure within the detection chamber 40 would not produce a sufficient force or move the ball 94 into engagement with the sealing surface of the equalizing passageway 90. Accordingly, a small or gradual decrease in the pressure within the detection chamber 40 will be equalized by the flow of the pressurized gas from the cylinder 22 and/or the prime chamber 42 through the equalizing passageway 90 and into the detection chamber 40. However, on detection of a fire, the detector tube 18 will rupture creating a rapid decrease or loss in the pressure within the detection chamber 40. This will cause the ball 94 to be moved towards the detection chamber 40 such that the ball 94 creates a seal and prevents any further flow through the equalizing passageway 90. This seal then causes a significant imbalance in pressure such that the pressure within the primed chamber 42 is greater than the pressure within the detection chamber 40 which is open to the atmosphere once the detector tube 18 is ruptured. This resulting change in pressure differential causes the force acting on the valve member 30 to be greater from the primed chamber 42 side than the detection chamber 40 side. Accordingly, this causes the valve member 30 to move towards the detection chamber 40 such that first and second fluid communication passageways are opened.

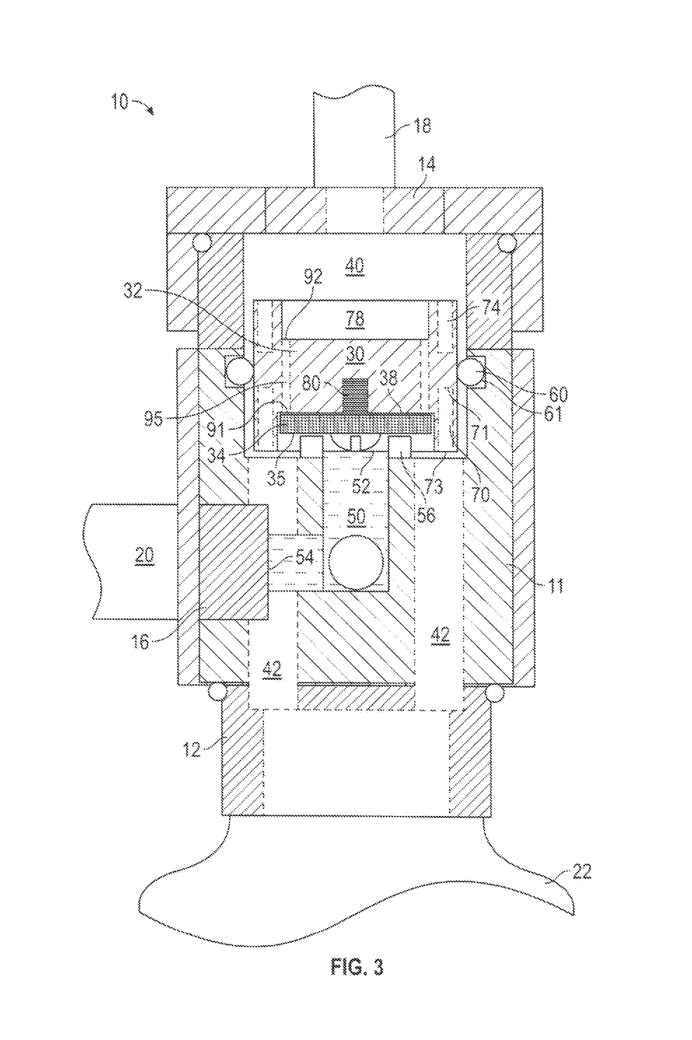

Referring now to FIG. 3, in an alternative embodiment, the control valve 10 may operate in the same way as described above apart from the equalizing passageway 90. In this embodiment, the equalizing feature may be provided by the sealing component 34 comprising a resilient sealing member which is normally located within a seat 38 provided in the carrier part 32. The sealing component 34 may comprise a sealing disc member which is mounted on a central shaft 80. The sealing disc may be configured to allow passage of an equalizing pressure around the periphery of the sealing disc towards a plurality of channels 95 disposed on the carrier part 32. Each channel 95 may comprise an exit region 92 on the detection chamber 40 side of the valve member 30 and an entry region 91 located on the seat 38 at a location which would normally be adjacent to the periphery of the sealing disc.

The seat 38 may be normally spaced from the sealing disc 34 by a certain amount (or a predetermined distance) and the edge or periphery of the disc 34 may be spaced from or flexed or deformed such that pressurized fluid (gas) can escape and flow around the edge of the sealing disc 34. This therefore enables gas from within the primed chamber 42 to flow into the detection chamber 40 in a restricted flow. This flow of pressurized gas will tend to maintain substantially equal pressures in the detection chamber 40 and the primed chamber 42. Accordingly, this maintains the integrity of the overall system.

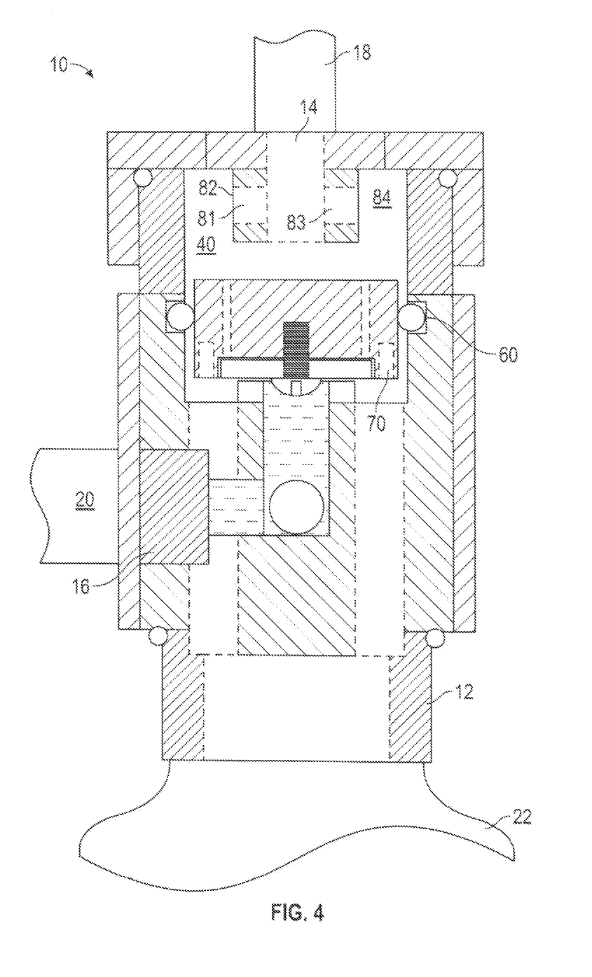

Referring now to FIG. 4, in yet another embodiment of the present technology, the control valve 10 essentially works and operates in the same way as the embodiments described above. However, in this embodiment, the detection chamber 40 includes an abutment stop 82 configured to prevent the carrier component 32 from moving all the way to the end of the detection chamber 40. The abutment stop 82 may comprise exit regions 81, 83 configured to provide a flow path to the first outlet 14. Accordingly, in the open, discharging position, the pressurized extinguishant flows from the cylinder 22 through the grooves 70, past the seal 60, and then into an annular void 84 surrounding the abutment stop 82. The pressurized extinguishant may then flow through the exit regions 81, 83 and into the detection tube 18.

Referring now to FIG. 8, an exemplary embodiment of a fire suppression system may comprise a single pressurized cylinder 22 containing an extinguishant, a bi-directional valve 10 connected to the cylinder 22, a pressurized detection tube 18 connected to an outlet of the bi-directional valve 10, and an unpressurized discharge tube 20 fluidly coupled to at least one discharge head 21. Multiple discharge heads 21 may be mounted or installed in separate chambers 96, 98 or in locations which may not receive the extinguishant released from the detection tube 18. For example, each discharge head 21 may be directed towards any essential, critical, or expensive components to help ensure protection of these components against fire. In this embodiment, a rupture of the detection tube 18 causes the activation of the bi-directional control valve 10 which simultaneously causes a release of extinguishant from the single cylinder 22 through both the detection tube 18 and the discharge tube 20.

Referring now to FIG. 9, an alternative embodiment of a fire suppression system may comprise two separate pressurized cylinders 22. A first dedicated cylinder 102 may be used to provide extinguishant to the detection tube 18 and a second dedicated cylinder 104 may be used to provide extinguishant to the discharge tube 20. In this embodiment, a direct control valve 66 may be mounted to the first dedicated cylinder 102 and an indirect control valve 68 may be mounted to the second dedicated cylinder 104. The system comprises a shared detection tube 18 that extends from the direct valve 66 to the activation port of the indirect valve 68. Accordingly, the rupture of the detection tube 18 will cause the direct valve 66 to activate and the extinguishant from the first dedicated cylinder 102 will be released from the detection tube 18. In addition, the rupture of the detection tube 18 will activate the indirect valve 68 such that the extinguishant from the second dedicated cylinder 104 will be released through the discharge tube 20 and any associated discharge heads 21. Accordingly, again, in these systems the rupture of the single detection tube 18 causes two extinguishant release passageways to be opened causing extinguishant to be released through the actual rupture in the detection tube 18 and though the discharge heads 21.

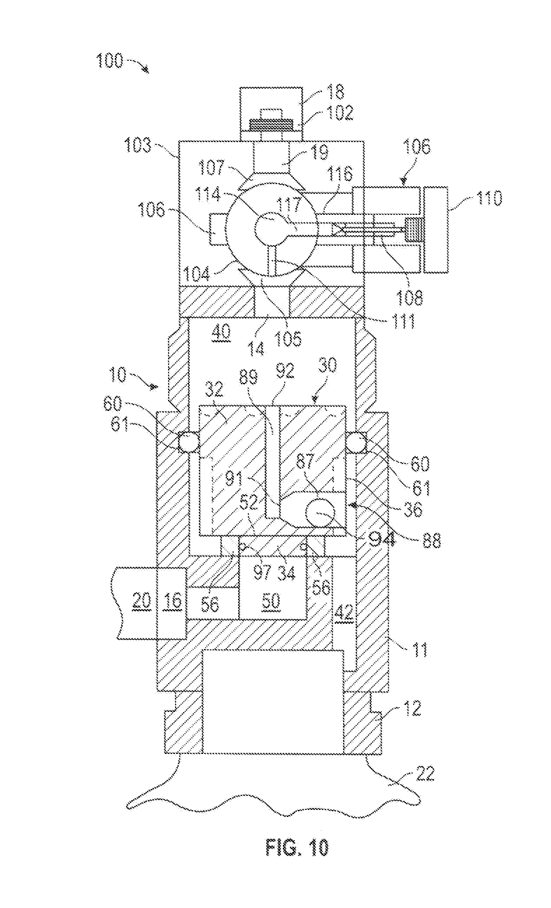

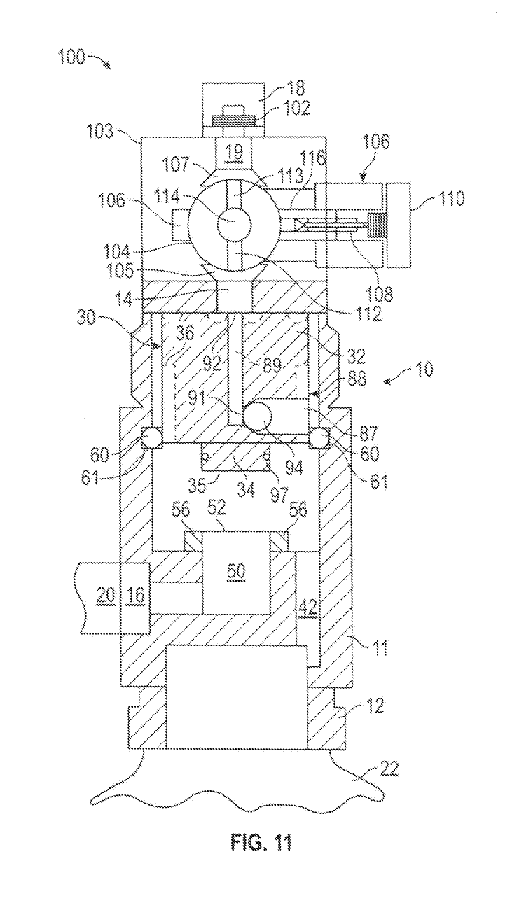

Referring now to FIGS. 10 and 11, in an alternative embodiment, the bi-directional control valve 10 may be configured to provide an equalizing function to automatically re-pressurize the detection tube 18 if the detection tube 18 slowly loses pressure. In this embodiment, the sealing component 34 may comprise the same planar dimensions as the central portion 50. For example, the sealing component 34 may function as a generally cylindrical plug configured to fit within a tubular end portion of the central portion 50. The sealing component 34 may comprise an o-ring 97 carried around the periphery thereof which is dimensioned to create a seal with an inner surface of the tubular end portion.

The sealing component 34, in a normal inoperative closed position, is configured to seal the central portion 50 from the detection chamber 40, thereby creating a seal between the primed chamber 42 and the discharge tube 20. In a discharged position (shown in FIG. 11), the sealing component 34 is spaced from the central portion 50 such that the extinguishant may flow from the cylinder 22 to the discharge tube 20.

The valve member 30 comprises a re-pressurizing or equalizing passageway 88 including an internal valve mechanism. In particular, the carrier component 32 defines a first passageway 87 co-operating with a substantially narrower second passageway 89. These first and second passageways 89, 87 connect at an entry region 91 to provide a continuous passageway from the primed chamber 42 to the detection chamber 40. The second passageway 89 defines an exit region 92 which is open to the detection chamber 40. However, the internal valve mechanism may be configured to selectively restrict the flow through the first and second passageways.

The internal valve mechanism may comprise any suitable device such as a ball 94 or spherical valve member configured to seal the first passageway 87 from the second passageway 89 on the detection of a fire. In a normal inoperative condition, the ball 94 is contained within the first passageway 87 but there is an equalizing passageway extending from the detection chamber 40 to the primed chamber 42 such that the pressures will be equalized. As shown in FIG. 10, a greater pressure within the detection chamber 40 would only force the ball member 94 away from the tapered or flared sealing surface of the first passageway 87. A slight decrease or gradual decrease in the pressure within the detection chamber 40 would not produce a sufficient force or move the ball 94 into engagement with the sealing surface of the first passageway 87. Accordingly, a small or gradual decrease in the pressure within the detection chamber 40 will be equalized by the flow of the pressurized gas from the cylinder 22 and/or the prime chamber 42 through the passageways 87, 89 and into the detection chamber 40. However, on detection of a fire, the detector tube 18 will rupture and will cause catastrophic and rapid decrease in the pressure within the detection chamber 40. This will cause the ball 94 to move towards the detection chamber 40 such that the ball 94 creates a seal and prevents any further flow through the passageway 89. This seal then causes a significant imbalance in pressure such that the pressure within the primed chamber 42 is significantly greater than the pressure within the detection chamber 40 which is open to the atmosphere after the rupture of the detector tube 18. This resulting change in pressure differential causes the force acting on the valve member 30 to be greater from the primed chamber 42 side than the detection chamber 40 side. Accordingly, this causes the valve member 30 to move towards the detection chamber 40 such that two extinguishant release passageways are simultaneously opened. The first extinguishing passageway relates to the release of the extinguishant from the cylinder 22 through the grooves 36 in the valve member 30 and around the seal and out through the detector tube 18. The second extinguishing passageway relates to the release of the extinguishant from the cylinder 22 through the central portion 50 and to the discharge tube 20 and any discharge heads 21. Accordingly, the movement of the valve member 30 also creates this free passageway of the extinguishant through the discharge tube 20.

With continued reference to FIGS. 10 and 11, in some embodiments an isolation valve 100 is used to selectively connect and disconnect the bi-directional valve 10 from the detector tube 18. Disconnecting the detector tube 18 from the bi-directional valve 10 puts the fire suppression system into an inoperable state, allowing the user, for example, to service or safely monitor the pressure of the extinguishant in the pressurized cylinder 22. Conversely, the isolation valve 100 may be used to place the fire suppression system is in an operable state when the detector tube 18 is connected to the bi-directional valve 10. The isolation valve 100 is controllable and configurable between a first and second state. For example, the isolation valve 100 may be selectively positioned in either an open state or a closed state, in which the open state defines an operational configuration and the closed state defines an inoperable configuration.

The isolation valve 100 may be located between the bi-directional control valve 10 and the detector tube 18, in which the isolation valve 100 is mounted on the bi-directional control valve 10 atop the outlet port 14, and has a connector 102 on an upper surface for connecting to the detector tube 18. The isolation valve 100 may comprise a valve member 104, an indexing key 106, a valve 108, and a contents gauge 110, in which the indexing key 106 and the valve 108 are mounted to opposite sides of the valve member 104, and the contents gauge 110 is connected to a front face of the valve 108.

The valve member 104 may be configured as a spherical member located within a chamber provided by a valve member housing 103. The valve member housing 103 may include sealing members in the form of PTFE a pair of sealing discs 105, 107, positioned at the openings of the outlet port 14 and the detector tube inlet 19. The valve member 104 may be rotatable through 90° and be configured to selectively direct the pressure from the bi-directional valve 10. This selective directing of pressure is enabled through three channels 111, 112, 113 which all extend from an outer surface of the valve member 104 to a central void 114. A first channel 111 may be substantially perpendicular to a conduit 117 leading through a drive stem 116 to the valve 108 and link the drive stem 116 to the outlet port 14. A second and third channel 112, 113 may be aligned to form a linear conduit through the valve member 104, in which the second and third channels 112, 113 lie on a substantially perpendicular plane to the plane that the first channel 111 and drive stem 116 lie on.

For example, FIG. 10 shows how the isolation valve 100 in the closed state allows pressure from the bi-directional valve 10 to flow through the first channel 111 to the valve 108, so that the pressure of the bi-directional valve 10 can be read from the contents gauge 110. FIG. 11 shows how the isolation valve 100 in the open state directs the flow from the bi-directional valve 10 to the detector tube 18 through the second and third channels 112, 113.

The valve member housing 103 may comprise a slot (not shown) into which an end of a screwdriver (or a key) can be engaged to allow a user to move the isolation valve 100 between the open and closed positions.

The valve 108 regulates the flow into or out of the drive stem conduit 117 and selectively engages with the contents gauge 110, which measures the pressure of the enclosed volume in communication with the drive stem conduit. The valve 108 may comprise any may comprise any suitable system or device for allowing air or any other similar fluid to be flowed into the central void 114, such as a Schrader valve, a Presta valve, a quick connect one-way valve, or any other similar type of pneumatic fitting configured to prevent a fluid from flowing in an undesired direction

The isolation valve 100 can be identified as being in the open or closed states by the indexing key 106. For example, the indexing key 106 may comprise a disc magnet (not shown) which may be rotated with the valve member 104 through 90°. In use, the disc magnet is rotated from a position in which the central plane of the magnet is substantially horizontal to a position in which the plane is substantially vertical. The indexing key 106 may be configured to cooperate with a sensor to indicate what state the isolation valve 100 is in. For example, in one embodiment, the sensor may comprise a cross-arrangement of reed switches, in which the disc magnet induces a magnetic field within the reed switches to close the relevant reed switch which will then activate a respective light (not shown) located within a circuit connected to the respective reed switch. The orientation of the valve member 104 in the open or closed state may then be clearly identified by the user to indicate what state the bi-directional control valve 10 is in.

These and other embodiments for methods of controlling a hazard may incorporate concepts, embodiments, and configurations as described with respect to embodiments of apparatus for controlling a hazard as described above. The particular implementations shown and described are illustrative of the technology and its best mode and are not intended to otherwise limit the scope of the present technology in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The technology has been described with reference to specific exemplary embodiments. Various modifications and changes, however, may be made without departing from the scope of the present technology. The description and figures are to be regarded in an illustrative manner, rather than a restrictive one and all such modifications are intended to be included within the scope of the present technology. Accordingly, the scope of the technology should be determined by the generic embodiments described and their legal equivalents rather than by merely the specific examples described above. For example, the steps recited in any method or process embodiment may be executed in any order, unless otherwise expressly specified, and are not limited to the explicit order presented in the specific examples. Additionally, the components and/or elements recited in any apparatus embodiment may be assembled or otherwise operationally configured in a variety of permutations to produce substantially the same result as the present technology and are accordingly not limited to the specific configuration recited in the specific examples.

Benefits, other advantages and solutions to problems have been described above with regard to particular embodiments; however, any benefit, advantage, solution to problems or any element that may cause any particular benefit, advantage or solution to occur or to become more pronounced are not to be construed as critical, required or essential features or components.

As used herein, the terms “comprises”, “comprising”, or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

The present technology has been described above with reference to a preferred embodiment. However, changes and modifications may be made to the preferred embodiment without departing from the scope of the present technology. These and other changes or modifications are intended to be included within the scope of the present technology, as expressed in the following claims.

1. A fire suppression system, comprising:
a cylinder configured to contain a fire extinguishant material;
a control valve connected to the cylinder and configured to controllably seal the cylinder under a first pressure, wherein the control valve comprises:
an inlet fluidly linked to the cylinder;
a first outlet port open to a second pressure;
a second outlet port;
a valve member movable between a closed position and an open position within the control valve for opening and closing:
a first extinguishant release passageway between the inlet and the first outlet port; and
a second extinguishant release passageway between the inlet and the second outlet port;
a detector tube connected on a first end to the first outlet port, wherein:
the detector tube is configured to be held at the second pressure; and
a loss of the second pressure from the detector tube causes the valve member to move from the closed position to the open position to unseal the cylinder and release the fire extinguishant material through both the first and second extinguishant passageways; and
a discharge tube connected to the second outlet port.

2. A fire suppression system according to claim 1, wherein the control valve further comprises an equalizing passageway to enable pressurized fluid to flow therethrough when the valve member is in the closed position.

3. A fire suppression system according to claim 2, wherein the equalizing passageway:
is open when the detection tube is pressurized; and
is closed when the first pressure is reduced.

4. A fire suppression system according to claim 2, wherein the equalizing passageway is configured to maintain the second pressure in the detector tube.

5. A fire suppression system according to claim 2, wherein the equalizing passageway:
is open when the valve member is in a closed position; and
is closed when the valve member is in an open position.

6. A fire suppression system according to claim 1, wherein:
the closed position of the valve member closes off the first and second extinguishant release passageways to prevent the release of the fire extinguishant material; and
the open position of the valve member opens the first and second extinguishant release passageways to allow the simultaneous release of the fire extinguishant material from the first and second outlet ports.

7. A fire suppression system according to claim 1, wherein the control valve further comprises:
a primed chamber disposed between the inlet and a first side of the valve member, wherein the first side comprises a first surface area exposed to the first pressure; and
a detector chamber disposed between the first outlet and a second side of the valve member, wherein:
the second side comprises a second surface area exposed to the second pressure; and
the second surface area is larger than the first surface area.

8. A fire suppression system according to claim 1, further comprising:
a second cylinder connected to a second end of the detector tube, wherein the second cylinder is configured to contain a second fire extinguishant material; and
a second control valve disposed between the second cylinder and the second end of the detector tube, wherein the second control valve is configured to controllably seal the second cylinder and release the second fire extinguishant material in response to the loss of the second pressure from the detector tube.

9. A fire suppression system according to claim 1, wherein the discharge tube further comprises a discharge head configured to disperse the released fire extinguishant material.

10. A pneumatically actuated valve for a pressurized cylinder containing a fire extinguishant material, comprising:
a body, comprising:
an inlet configured to connect to and be fluidly linked to the cylinder;
a first outlet port open to a first pressure; and
a second outlet port; and
a valve member movable and disposed within the body, wherein the valve member is configured to:
controllably seal the cylinder under a second pressure;
open and close a first extinguishant release passageway extending between the inlet and the first outlet port;
open and close a second extinguishant release passageway extending between the inlet and the second outlet port;
move between:
a closed position, wherein the first and second extinguishant release passageways are closed off to prevent the release of the fire extinguishant material;
an open position, wherein the first and second extinguishant release passageways are opened to allow the simultaneous release of the fire extinguishant material from the first and second outlet ports; and
move from the closed position to the open position in response to a loss of the first pressure.

11. A pneumatically actuated valve according to claim 10, wherein the control valve further comprises:
a primed chamber disposed between the inlet and a first side of the valve member, wherein the first side comprises a first surface area exposed to the second pressure; and
a detector chamber disposed between the first outlet and a second side of the valve member, wherein:
the second side comprises a second surface area exposed to the first pressure; and
the second surface area is larger than the first surface area.

12. A pneumatically actuated valve according to claim 11, wherein the valve member further comprises an equalizing passageway to enable pressurized fluid to flow from the primed chamber to the detector chamber when the valve member is in the closed position.

13. A pneumatically actuated valve according to claim 12, wherein the valve member is configured to close the equalizing passageway when the valve member moves into the open position.

14. A method of providing a fire suppression system, comprising:
installing a detector tube within a fire prevention area, wherein the detector tube is configured to be pressurized to a first pressure;
installing a discharge tube within the fire prevention area;
coupling an inlet of a control valve to a cylinder configured to contain a fire extinguishant material under a second pressure;
coupling a first end of the detector tube to a first outlet port of the control valve; and
coupling a first end of the discharge tube to a second outlet port of the control valve, wherein the control valve is configured to:
open a first extinguishant release passageway between the inlet and the first outlet port in response to a loss of the first pressure; and
open a second extinguishant release passageway between the inlet and the second outlet port in response to the loss of the first pressure; and
allow the fire extinguishant material to be simultaneously released through both the first and second outlet ports.

15. A method of providing a fire suppression system according to claim 14, further comprising maintaining the first pressure in the detector tube by allowing a pressurized fluid to flow from the cylinder through an equalizing passageway formed into a valve member disposed within the control valve.

16. A method of providing a fire suppression system according to claim 15, wherein:
the equalizing passageway is open when the valve member is in a closed position; and
the equalizing passageway is closed when the valve member is in an open position.

17. A method of providing a fire suppression system according to claim 14, further comprising:
connecting a second cylinder containing a second fire extinguishant material to a second end of the detector tube; and
connecting a second control valve between the second cylinder and the second end of the detector tube, wherein the second control valve is configured to controllably seal the second cylinder and release the second fire extinguishant material into the detector tube in response to the loss of the first pressure from the detector tube.
